(19) United States
(12) Patent Application Publication
(10) Pub. No.: US 2022/0072613 A1
(43) Pub. Date: Mar. 10, 2022

(54) SUPPORTS FOR COMPONENTS DURING DEBINDING AND SINTERING

(71) Applicant: Tritone Technologies Ltd., Rosh HaAyin (IL)

(72) Inventors: Ofer BEN-ZUR, Hod-HaSharon (IL); Hagai PELED, Tel-Aviv (IL)

(73) Assignee: Tritone Technologies Ltd., Rosh HaAyin (IL)

(21) Appl. No.: 17/414,496

(22) PCT Filed: Dec. 12, 2019
(86) PCT No.: PCT/IL2019/051362

§ 371 Date: Jun. 16, 2021

Related U.S. Application Data
(60) Provisional application No. 62/780,273, filed on Dec. 16, 2018.

(51) Int. Cl. B22F 10/10; B33Y 10/00; B33Y 30/00; B22F 3/10; B22F 12/82; B22F 5/00

(52) U.S. Cl. CPC B22F 10/10; B33Y 10/00; B33Y 30/00; B22F 2003/1042; B22F 12/82; B22F 5/007; B22F 3/10

(57) ABSTRACT

A method for making a product or a part for a product wherein the product or part is made in a process using additive manufacture and requires sintering, the method comprising producing a support component with a shape complementary to the product or part, in an associated process, also using additive manufacture; and supporting the product or part during sintering by fitting the product or part into the complementary shape prior to placing in the furnace for sintering.

### RELATED APPLICATION

This application claims the benefit of priority from U.S. Provisional Patent Application No. 62/780,273 filed on 16 Dec. 2018, the contents of which are incorporated herein by reference in their entirety.

### FIELD AND BACKGROUND OF THE INVENTION

The present invention, in some embodiments thereof, relates to supports for components during debinding and sintering and, more particularly, but not exclusively, to supports that are suitable for the relatively complex shapes of parts that can be achieved using processes involving or including additive manufacture.

Additive manufacture may be used in different ways, as the whole or part of the process to manufacture components made up of different materials.

In some cases, the additive manufacture produces components require various kinds of heat treatment after manufacture. Thus for example green metal parts may be produced as a mix of powder and binder, and debinding and sintering may be required to remove the binder and fuse the metal powder.

During the high temperature sintering process, green parts shrink by some 10-25%. While the parts shrink and before the parts can fully attain their final density, the forces of gravity and friction may distort the parts if they are not adequately supported. At high temperatures, in particular those close to the melting point, the parts are more sensitive to deflection and distortion.

To avoid this, it is common in powder metallurgy technologies such as Metal Injection Molding, to design parts with large flat surfaces or to design several component features that have a common plane so that the flat surfaces can be supported by standard support components during sintering or can be supported against each other.

It is common to lay the green parts on plates made from materials that do not interact with the green parts during the thermal processes. For example, stainless steel parts are placed on ceramic plates, for example made of Alumina which is noted for its refractory properties, during the debinding and sintering processes.

FIG. 1 shows a ceramic plate 10 with drilled holes 12 that supports a part 14 having a flat surface and cylindrical extension—underside shown at 16.

FIG. 2 shows another ceramic plate 20, this time with machined posts 22, which fit into the concave shape of parts 24, underside shown at 26.

If neither of the above is suitable, then, custom or part-specific supports, which can be expensive to produce and represent added tooling costs, are needed. There are various types of specialized supports that are used. The simplest type of debinding and sintering support is a ceramic strip as shown at 30 in FIG. 3. The strips come in different heights and widths to meet the dimensional requirements of finished parts 32.

If the design permits, then molded-in supports may be provided, which adds a non-functional feature to the component.

FIG. 4 shows a part 40 which has a molded in support 42. As an alternative the support may be machined. FIG. 5 shows another example of parts 50 supported on a standard plate 52.

In Additive Manufacturing, complex geometries are manufactured, and suitable supports are required for production of parts with high accuracy and stability. However even the customized products of the existing art (FIGS. 3 and 4) do not provide supports which are suitable for complex geometries.

### SUMMARY OF THE INVENTION

The present embodiments relate to a process in which sintering supports are manufactured in the same processes as the components requiring sintering. In an embodiment the component and support may be provided in an integrated process that includes additive manufacturing.

According to an aspect of some embodiments of the present invention there is provided a method for making a product or a part for a product wherein the product or part is made in a process using additive manufacture, wherein the product or part once formed requires sintering, the method comprising:

producing a support component with a shape complementary to the product or part, also with a process using additive manufacture; and

supporting the product or part during the sintering by fitting the product or part into the complementary shape.

In an embodiment, the product or part comprises metallic powder in a binder.

In an embodiment, the support component is made from a material selected to have a melting point which is higher than a sintering temperature of the product or part.

In an embodiment, the support part is made from a material having a coefficient of expansion which is close to a coefficient of expansion of the product or part at the sintering temperature.

In an embodiment, the product or part comprises stainless steel and the support comprises Al₂O₃.

In an embodiment, the product or part comprises titanium and the support comprises ZrO₂.

In an embodiment, the product or part and the support comprise a same material.

In an embodiment, the same material comprises metal or wherein the same material comprises ceramic.

The method may comprise carrying out sintering with the support prior to the fitting for sintering the product or part.

The method may comprise making the product or part and the support using a single process on different stations of a multi-station machine.

The method may comprise making the product or part and the support together in a single added manufacture process and taking the product or part and support separately to the sintering process.

The method may comprise making the product or part and the support using a single print file.

The method may comprise identifying a common surface for the product or part and the support from the print file; and printing versions of the common surface filled in from opposite sides respectively for the product or part and the support, thereby to define the complementary shape.

In an embodiment, at least one of the product or part and the support is manufactured by:

printing a first mold using additive manufacture to define one layer of the product or part or support;

filling the first mold with a paste material, thereby forming a first layer;

printing a second mold on top of the first layer to define a second layer; and

filling the second layer, over the first layer, with a paste material; thereby to form a molded layered product or part or support.

In an embodiment, the fitting together the support and the part comprises adding a refractive layer between the part and the support.

In an embodiment, the refractive layer is a paste and is applied by coating or is a spray and is applied by spraying.

According to a further aspect of the present embodiments there is provided a device for manufacture of products or parts of products or support parts in a process using additive manufacture and requiring sintering, the support parts being to provide support to the products or parts of products during the sintering, the device comprising:

a plurality of stations, each for carrying out a respective stage of the process;

a conveyor component configured to carry printing trays between the plurality of stations; and

a controller, wherein one of the stations is an additive manufacture station configured to use additive manufacture to print a mold defining a layer of a part, one of the stations is a first paste dispensing station configured to spread a first paste into a space defined within the mold, and one of the stations is a drying station configured to dry the paste, the controller being configured to operate the conveyor component to present the tray to the stations successively until the part is complete.

In an embodiment, the conveyor component is a rotary component and the stations are arranged around a rotation path of the component.

The device may comprise a paste dispensing second station, the second space dispensing station being configured to spread a second paste into the space defined within the mold, the second paste being different from the first paste, the first paste dispensing station controllable to dispense onto the product or part of a product and the second paste dispensing station configured to dispense onto the support part.

The device may comprise a vacuum station, the vacuum station configured to cover respective trays with a vacuum hood and apply a vacuum to dry the first or the second paste.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified diagram illustrating a prior art ceramic support plate with drilled holes or pockets;

FIG. 2 is a simplified diagram illustrating a prior art ceramic support plate with machined posts;

FIG. 3 is a simplified diagram illustrating a prior art ceramic strip;

FIG. 4 is a simplified diagram illustrating a prior art molded in support;

FIG. 5 is a simplified diagram illustrating a prior art ceramic support plate with parts inserted therein;

FIG. 6 is a simplified diagram illustrating a part made using additive manufacture for which a custom-made support is needed;

FIG. 7 is a simplified diagram illustrating a custom made support for the part in FIG. 6 manufactured in the same or a similar process of additive manufacture in accordance with the present embodiments;

FIG. 8 is a simplified diagram showing the part of FIG. 6 and the support of FIG. 7 fitted together for sintering according to the present embodiments;

FIG. 9 is a simplified diagram of a view from above of a rotating table device having processing stations for producing a part and a support customized for the part in an integrated production process in accordance with the present embodiments; and

FIG. 10 is a simplified flow chart of the integrated production process according to the present embodiments and which may be applied to the rotating table device of FIG. 9.

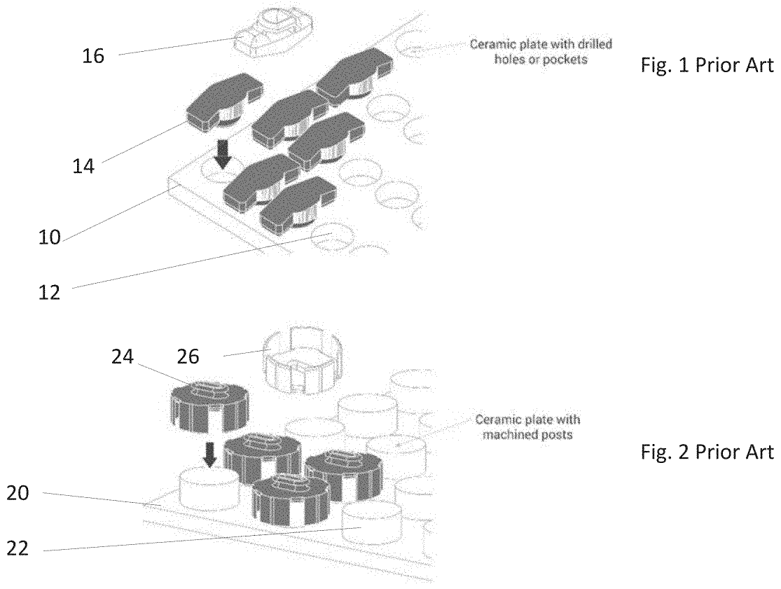

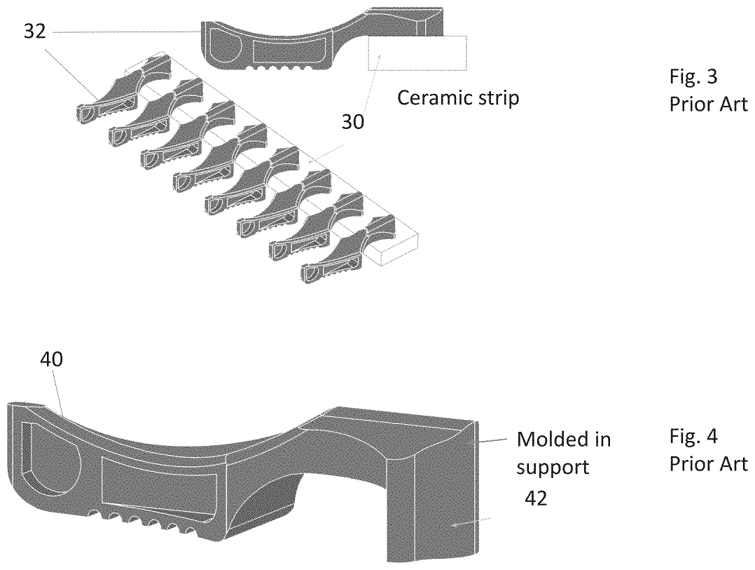

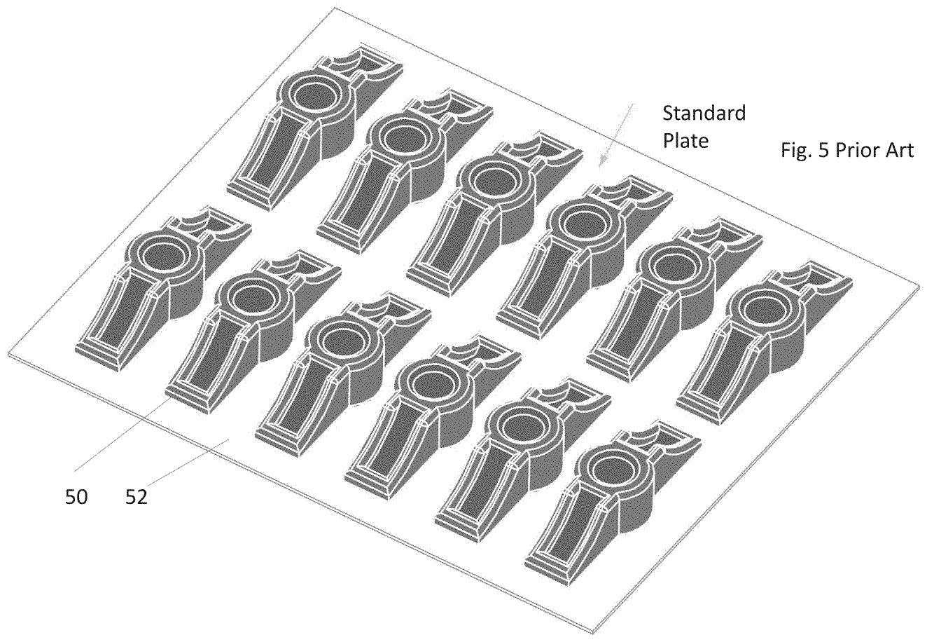

### DESCRIPTION OF SPECIFIC EMBODIMENTS OF THE INVENTION

The present invention, in some embodiments thereof, relates to supports for components during debinding and sintering and, more particularly, but not exclusively, to supports that are suitable for the relatively complex shapes of parts that can be achieved using processes involving or including additive manufacture.

The present embodiments provide a method for making a product or a part for a product wherein the product or part is made in a process using additive manufacture and requires sintering, the method comprising producing a support component with a shape complementary to or at least customized for supporting the product or part, in an associated process also including additive manufacture; and supporting the product or part during sintering by fitting the product or part into the complementary shape prior to placing in the furnace for sintering.

A prior and as yet unpublished proposal by the present inventors teaches a method and apparatus for manufacturing a molded layered product which comprises: printing a mold using additive manufacture to define one layer of the product; filling the mold with a paste or cast material or the like, thereby forming a first layer; printing a second mold on top of the first layer to define a second layer, again using additive manufacture; and filling the second mold, over the first layer, with the same paste or cast material. Alternating mold printing and pasting steps are continued until a molded layered product or part product is formed.

In the above process, the final product often requires debinding and sintering, and the present embodiments may provide the customized support part using the same mold and paste process.

In an embodiment, an integrated process is provided in which the product part and a custom-made support for the product part are manufactured together in a single process involving additive manufacture. The product part may be made using conventional additive manufacture, or it may be made using the above-mentioned proposal, and the support may be manufactured together with the product part using the same or a very similar process.

In embodiments, the support is not made of the same material as the product part but rather from a material that has a higher melting point than the sintering temperature of the material in the product part. The expansion coefficient of the support part however may be as close as possible over the sintering temperature to that of the product part.

In the above process the support is sintered together with the part and is for one time use. The support may be of a different material from the part. Alternatively the support may be of the same material to ensure the same expansion coefficient for both the part and support. In this case the support may be lightly coated at the interface surface with a different material to prevent fusion during the sintering process.

In another embodiment, the supports are made in advance from a different material than from the part, and sintered before use. In this case the supports may be used multiple times.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

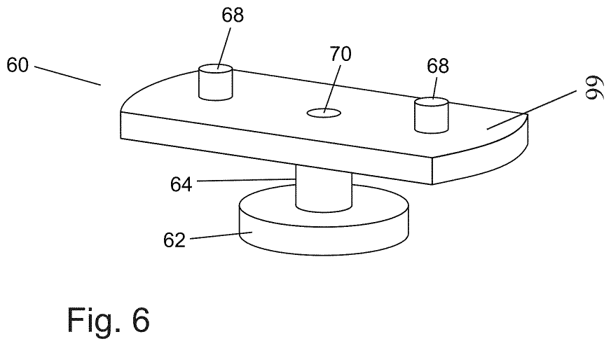

Reference is now made to FIG. 6 which illustrates an exemplary component 60 which may be made inter alia of metal, including steel or titanium, or may be made of ceramic. The component or part may be made using additive manufacture, for example with the technique of the above mentioned prior proposal of printing a mold for each layer and then filling with paste before proceeding to a following layer. The above-mentioned materials are particularly suitable for the technique as the metal or ceramic may be provided as a powder in a paste with a binder. After removing the mold, the binder is removed during debinding process and the powder fuses during sintering.

The exemplary component shown has a shape including a lower cylinder 62 supported by an intermediate cylinder 64 of smaller radius which in turn supports a generally rectangular shape 66. Two small cylinders 68 extend from the generally rectangular shape 66 and a small hole 70 is located in the generally rectangular shape above intermediate cylinder 64. Parts similar to the exemplary component of FIG. 6 are often required in mechanical constructions and may often be ordered according to very precise specifications.

Looking from below at component 60 the outer contour follows the bottom of lower cylinder 62 and then rises around the outer circumference of the lower cylinder. The contour then rises to the lower surface of the upper rectangular shape 66. Thus support is required that fits around the lower cylinder and then has shoulders that extend to hold the rectangular shape from below. More particularly the lower surface of the upper rectangular shape 66 is suspended in midair and as a result may deflect and distort due to gravity when softened due to heating. A support is thus needed for the rectangular shape since at the very high temperature, the material is soft and the Youngs Module is relatively very low.

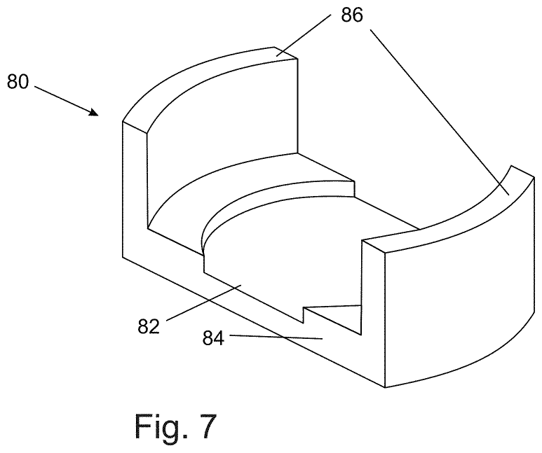

FIG. 7 illustrates a support 80 having a shape which provides a solution for supporting the exemplary component 60. The support 80 is for example made from a ceramic such as Al₂O₃ (Alumina), and the material of the ceramic is selected to have a melting point which is higher than the sintering temperature of the component 60. The material is also selected to have a coefficient of expansion which is close to that of component 60, at least for the sintering temperature.

Support 80 has a circular cutout 82 in its base 84, which base is complementary to lower cylinder 62, so that lower cylinder 62 fits into the circular cutout 82. Two shoulders 86 extend upwardly to reach the lower surface of generally rectangular shape 66. It is noted that the shoulders do not need to extend over the entire lower side of generally rectangular shape 66, it being noted that only a supporting fit is required, not an all-encompassing fit.

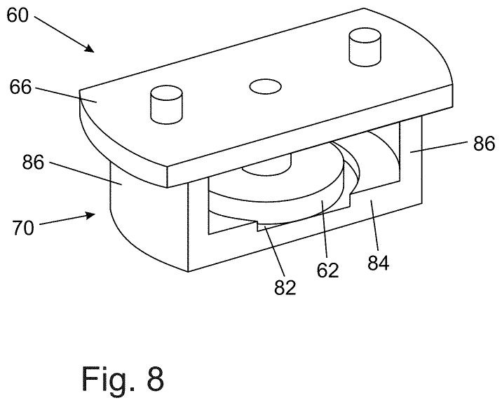

Reference is now made to FIG. 8, which illustrates part 60 fitted together with support 70 in preparation for debinding and sintering. As discussed lower cylinder 62 of the part 60 fits into the circular cutout 82 in the base 84 of the support. The shoulders 86 extend upwardly to reach the lower surface of generally rectangular shape 66. Thus all the lower facing surfaces of part 60 are supported during the sintering process.

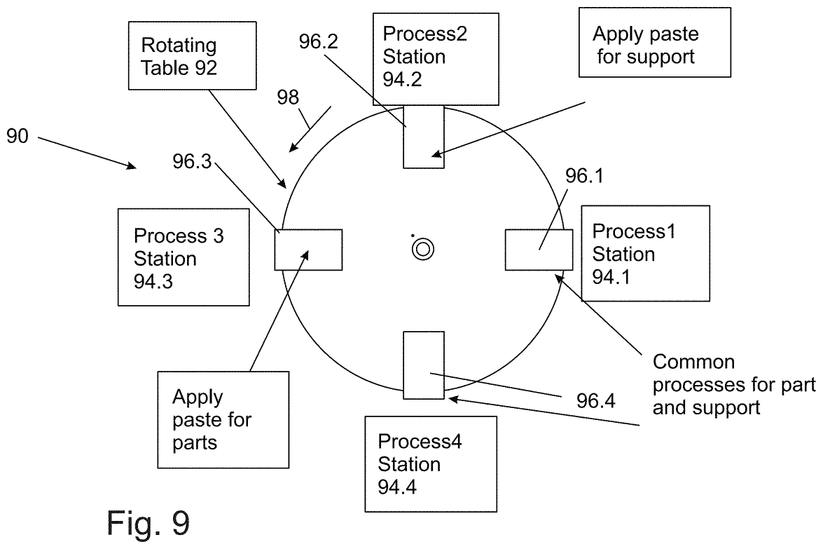

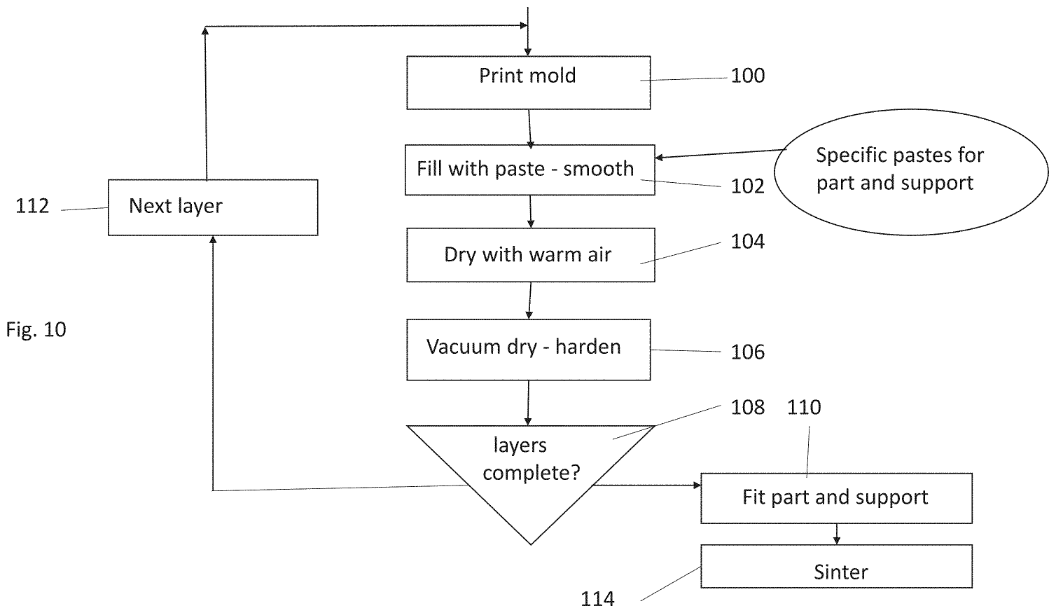

Reference is now made to FIG. 9, which is a simplified diagram illustrating a multi-station printing machine 90 for printing metal parts and supports together in an integrated process. The machine comprises a rotating table 92 here shown with four stations 94.1 . . . 94.4, although it is noted that four stations are purely exemplary and any number of stations may be provided as suitable for the process. The table has printing pallets or plates 96.1 . . . 96.4 that rotate with the table and the stations carry out respective stages of the printing process, which are discussed in FIG. 10 below. The various stations may work together to print the product or part and the corresponding support part in parallel. Arrow 98 indicates a direction of rotation of table 92. There are several processes performed to make a single layer, and certain processes are common to the part and support, and other processes are specific to each. Thus, if the product and the support are going to use different materials then a sequence that may be needed may include:

Printing the mold;

Applying paste for the part (this stage is carried out for the metal part and not for the support);

Applying paste for the support (this stage is carried out for the ceramic part only);

Drying; and

Hardening with vacuum;

each of these processes may be provided at a specified station, thus giving five stations. For any specific tray, only four of the five stations are activated. In this way, a single production process may produce both the part and the support in parallel in an integrated production process.

Reference is now made to FIG. 10, which is a simplified diagram showing the various stages of a process including additive manufacture according to the above-mentioned proposal and which may be applied to the present embodiments to make the part and support together on the rotary table of FIG. 9. A first box 100 indicates printing a mold to define a layer to be printed. The mold may be printed using known Additive Manufacturing technology and a print head using inkjet nozzles. Box 102 indicates spreading a paste material to fill the mold printed in box 100. A squeegee or blade may spread the paste material smoothly across the mold. The paste material may then form a layer of the eventual molded layered part but is currently soft, containing considerably liquid.

As discussed above in respect of FIG. 9, the part and support may use different paste materials, and may thus be carried out at different stations.

In box 104 the layer is dried with a stream of warm air. Then—106—a vacuum chamber may be placed over the printing plate and the layer is exposed to vacuum for a preset time. The vacuum causes water or other liquid within the paste to exceed boiling point and to evaporate from the paste, resulting in hardening. At this point the layer may be planed.

In box 108 the result of the process is sent for printing subsequent layers—112—until the product or part or support is complete.

Once complete the part and support are fitted together 110 and enter the furnace for sintering. In embodiments an interface layer may be added between the part and the support. The interface layer may be a ceramic and may be added as a paste or as a spray.

The molds may be printed using any standard mold printing material that is strong enough to hold the paste material. In embodiments the layer may be cast, and in such cases the mold may be required to hold the casting material at casting temperatures and other casting conditions.

Any standard 3D printing technique, such as fused deposition modeling (FDM) or Inkjet printing, may be used to print the mold.

In embodiments, the mold printing material has a melting point temperature which is lower than a melting point of the paste or the cast or other filling material, so that heating can be used to clean away the mold once the product is ready. Alternatively, the mold can be removed by dissolving in a suitable solvent.

The cast material may be any material that can fill a mold and which can subsequently be hardened, say by drying or cooling, or by any energy activation transition reaction or sintered to endow the product with the properties needed, however in the present embodiments it is specifically sintering that is addressed. In embodiments the cast material or paste may be a mixture of a binder, such as wax or monomer or oligomer activated to impart hardening or polymer emulsion or dissolved polymers that dry to harden the cast material, and either a ceramic powder or a metal powder or a mix of materials. Typically metal powder would be used for the part and ceramic powder for the support, but some products may use ceramics for the product as well and some products may use metal for the support.

The material used to fill the mold may include a slip, slurry or paste mixture being a suspension of ceramic or metal particles, optionally a mix of a few powders, in a liquid carrier, such as water or an organic solvent such as polyolefine, Alcohol, glycol, polyethyleneglycol, glycol ether, glycol ether acetate and other) and the cast material may comprise a mixture, such as a water- or solvent based composition of 60-95% by weight of powder or powder mixture.

In embodiments, the mold printing material may have a viscosity which is higher than the viscosity of the paste or other filling material, so that the mold remains intact when the paste material is spread. The paste material may have good wetting properties to fill the mold.

Spreading the paste, or casting or pouring, may be carried out at an elevated temperature, with tight control of materials to provide the mechanical properties necessary. Pouring may use a liquid dispensing system that consists of a dispensing control unit. The quantity of filling material may be set according to supplied sub mold parameters such as volume, overflow factor, etc. Then the paste material may be leveled by mechanical means such as a squeegee, as mentioned above, or a blade or under its own self leveling property with an optional vibrating procedure.

Later on, the Sub-Molds, that is the molds of the individual layers, may be removed by exposing the assembly to a higher temperature, or using a chemical dissolving process say with an acid or by immersion in solvent to dissolve the mold material or other processes. Suitable temperatures in the case of a wax based mold may be in the range of 100-200° C.

A debinding and sintering stage may involve increasing the temperature to allow debinding and sintering of the active part of the cast material, and typical temperatures for de binding and sintering are in the range of 200° C.-1800° C. depending on the exact material and required mechanical properties of the final product.

The support material may be a ceramic material and in one embodiment is sintered together with the metal parts. Thus the ceramic support part is at the green stage as is the metal part. In such a case, the support material is selected so that the shrinkage of both materials is similar. Such a support is for one time use.

Alternatively, the support material is an already sintered ceramic material. The support is attached to the part for the thermal processing but since it has already been sintered, the support part may not change at all. The support part can be used multiple times and in many processes.

As a further alternative, the support part may be made from the same metal material as the part itself and is sintered together with the metal part. The support part is at the green stage as is the part.

To prevent the part from fusing with the support in the sintering process, the support part may be coated or sprayed etc. with a fine refractory material such as Al₂O₃ to serve as an interface layer. The shrinkage of both parts is similar of course but the layer of the refractory material protects the assembly from fusing together.

In embodiments, the supports are built by the same method as the product parts molding a paste that includes a powder with binder. In embodiments a different paste is used.

During debinding and sintering, the part is mated with its customized support and the two parts are placed together in the furnace. After thermal treatment, the support part is removed.

It is expected that during the life of a patent maturing from this application many relevant additive manufacture and molding technologies, including those for working with ceramics and metal, will be developed and the scopes of corresponding terms are intended to include all such new technologies a priori.

The terms “comprises”, “comprising”, “includes”, “including”, “having” and their conjugates mean “including but not limited to”.

The term “consisting of” means “including and limited to”.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. In both cases, the present description is to be construed as if such embodiments are set out explicitly. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

In addition, any priority document(s) of this application is/are hereby incorporated herein by reference in its/their entirety.

1. A method for making a product or a part for a product wherein the product or part is formed by layerwise filling of a mold, the mold made using additive manufacture, wherein the product or part once formed requires sintering, the method comprising:
producing a support component with a shape complementary to said product or part, also by layerwise filling of a mold, the mold made using additive manufacture; and
supporting said product or part during said sintering by fitting said product or part into said complementary shape.

2. The method of claim 1, wherein said product or part comprises metallic powder in a binder.

3. The method of claim 1, wherein said support component is made from a material selected to have a melting point which is higher than a sintering temperature of said product or part.

4. The method of claim 3, wherein said support part is made from a material having a coefficient of expansion which is close to a coefficient of expansion of said product or part at said sintering temperature.

5. The method of claim 1, wherein the product or part comprises stainless steel and the support comprises Al₂O₃.

6. The method of claim 1, wherein the product or part comprises titanium and the support comprises ZrO₂.

7. The method of claim 1, wherein the product or part and the support comprise a same material.

8. The method of claim 7, wherein said same material comprises metal or wherein said same material comprises ceramic.

9. The method of claim 1, comprising carrying out sintering with the support prior to said fitting for sintering said product or part.

10. The method of claim 1, comprising making the product or part and the support using a single process on different stations of a multi-station machine.

11. The method of claim 1, comprising making the product or part and the support together in a single added manufacture process and taking the product or part and support separately to the sintering process.

12. The method of claim 1, comprising making the product or part and the support using a single print file.

13. The method of claim 8, comprising:
identifying a common surface for the product or part and the support from the print file; and
printing versions of said common surface filled in from opposite sides respectively for said product or part and said support, thereby to define said complementary shape.

14. The method of claim 1, wherein at least one of the product or part and the support is manufactured by:
printing a first mold using additive manufacture to define one layer of said product or part or support;
filling said first mold with a paste material, thereby forming a first layer;
printing a second mold on top of said first layer to define a second layer; and
filling said second layer, over said first layer, with a paste material; thereby to form a molded layered product or part or support.

15. The method of claim 1, wherein said fitting together said support and said part comprises adding a refractive layer between said part and said support.

16. The method of claim 15, wherein said refractive layer is a paste and is applied by coating or is a spray and is applied by spraying.

17. A device for manufacture of products or parts of products or support parts by layerwise filling of a mold, the mold formed in a process using additive manufacture, the products or parts of products requiring sintering, the support parts being to provide support to the products or parts of products during the sintering, the device comprising:
a plurality of stations, each for carrying out a respective stage of said process;
a conveyor component configured to carry printing trays between said plurality of stations; and
a controller, wherein one of said stations is an additive manufacture station configured to use additive manufacture to print a mold defining a layer of a part and a layer of a support, one of said stations is a first paste dispensing station configured to spread a first paste into a space defined within said mold, and one of said stations is a drying station configured to dry said paste, said controller being configured to operate said conveyor component to present said tray to said stations successively until said part is complete, and further to present said tray successively to said stations until said support is complete.

18. The device of claim 17, wherein said conveyor component is a rotary component and said stations are arranged around a rotation path of said component.

19. The device of claim 17, comprising a paste dispensing second station, the second space dispensing station being configured to spread a second paste into said space defined within said mold, said second paste being different from said first paste, said first paste dispensing station controllable to dispense onto said product or part of a product and said second paste dispensing station configured to dispense onto said support part.

20. The device of claim 17, further comprising a vacuum station, the vacuum station configured to cover respective trays with a vacuum hood and apply a vacuum to dry said first or said second paste.
